(19) United States
(12) Patent Application Publication
(10) Pub. No.: US 2015/0302717 A1
(43) Pub. Date: Oct. 22, 2015

(54) INFANT POSITION AND MOVEMENT MONITOR

(71) Applicant: Infant Watch , LLC, Medford, NJ (US)

(72) Inventors: Albert S. DeNittis, Medford, NJ (US); Samantha Kilgallen, Philadelphia, PA (US)

(73) Assignee: Infant Watch , LLC, Medford, NJ (US)

(21) Appl. No.: 14/258,134

(22) Filed: Apr. 22, 2014

(51) Int. Cl. G08B 21/02

(52) U.S. Cl. CPC G08B 21/0288

(57) ABSTRACT

A monitor system is provided for detection of the movement and position of a sleeping infant. The system includes an infrared detector, a station for receiving signals from the detector, and a garment to be worn by an infant provided with infrared reflectors. The reflectors create positional markers for detection by the detector. The detector sends signals to the receiving station based on the position of the reflectors on the garment worn by the infant. The station including alarms representative of the predetermined signals received from the detector.

### FIELD OF THE INVENTION

This present disclosure relates to a system for monitoring an infant's positioning and/or the movement while sleeping.

### BACKGROUND

It is recommended by physicians, specifically, pediatricians, that a sleeping or resting infant remain on their back to deter the potential of Sudden Infant Death Syndrome (SIDS).

Baby monitors with camera capability allow visualization of a sleeping infant. There are specific systems using a variety of sensors that will set off an alarm if the baby stops breathing.

There appears to be a need for visual verification of the breathing pattern of a sleeping infant. In existing monitors, it is difficult to see the detail of the breathing pattern and to detect the sleeping position of an infant. These limitations exist even when the camera within the system is operating with a night vision setting.

### SUMMARY

In one aspect of the disclosure, a monitor system is provided for detection of the movement of a sleeping infant. The system includes an infrared detector, preferably operating in conjunction with a video camera, and a receiving station, preferably having a visual display and alarms. A garment to be worn by the infant is provided, preferably in the form of a band with infrared reflectors positioned thereon. The band includes an elastic strap, having an adjustable coupling for securing the strap around the abdomen of the infant. The band is provided with reflectors that create positional detection markers. A projecting structure may be attached to the strap and forms a part of the band. The reflectors may be provided on the strap and/or the projecting portion. The infrared monitor preferably detects the position of the reflectors.

During breathing, the infant's abdomen moves up and down according to the typical breathing pattern. The band is fixed to the infant's abdomen and the reflectors move with the breathing. Discontinuation of normal reflector movement, associated with a change in breathing pattern, may result in an alarm signal. Similarly, the repositioning of the infant, such as by rolling to a side or stomach laying position, may result in a signal generating an alarm at the receiving station.

Other features of the present invention will become apparent from the detailed description to follow, taken in conjunction with the accompanying drawings.

### BRIEF DESCRIPTION OF THE DRAWINGS

For the purpose of illustrating the invention, there is shown in the drawings a form which is presently preferred; it being understood that the invention is not limited to the precise arrangements and instrumentalities shown.

FIG. 1 is a graphic illustration of an embodiment of a monitor system as contemplated by the present disclosure.

FIG. 2 shows a perspective view of a garment in the form of a band with reflectors thereon for use within the monitor system contemplated by the present disclosure.

### DETAILED DESCRIPTION

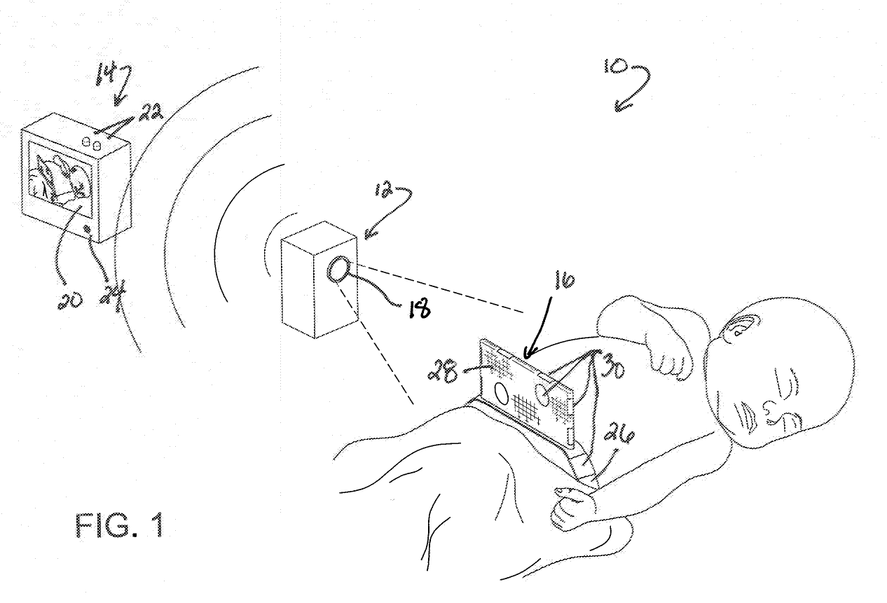

Referring now to the drawings, where like numerals identify like elements, there is shown in FIG. 1 a monitor system for detection of the movement and position of a sleeping infant. The monitor system is generally designated by the numeral 10 and is graphically shown in use. The monitor system 10 includes a detector 12, a receiving station 14 and a garment 16, which is worn by the infant. The detector 12 is contemplated to include a video camera with infrared functionality. The detector 12 includes an emitter/receiver 18 directed at the sleeping infant and the garment 16. The detector 12 is shown to wirelessly transmit signals to the receiving station 14. The signals may include the video transmission and positional data collected by the detector 12. The receiving station 14 is shown to include a video display 20 and two alarm lights 22.

A speaker 24 is provided for monitoring sound signals sent from the detector 12 and for projecting an audible alarm. The detector 12 may include a microphone for receiving ambient sound and transmitting the sound to the receiving station 14. Various control switches or the like (not shown) may be provided on the detector 12 and on the receiving station 18. As an alternative, or in addition to the receiver 14, the detector signals may be broadcast to and received by a smart phone, tablet, computer or a similar device (not shown), utilizing an available WIFI network, Bluetooth signal, cellular network or the like. Control of the detector 12 and the associated emitter/receiver 18 may also be accomplished through the device.

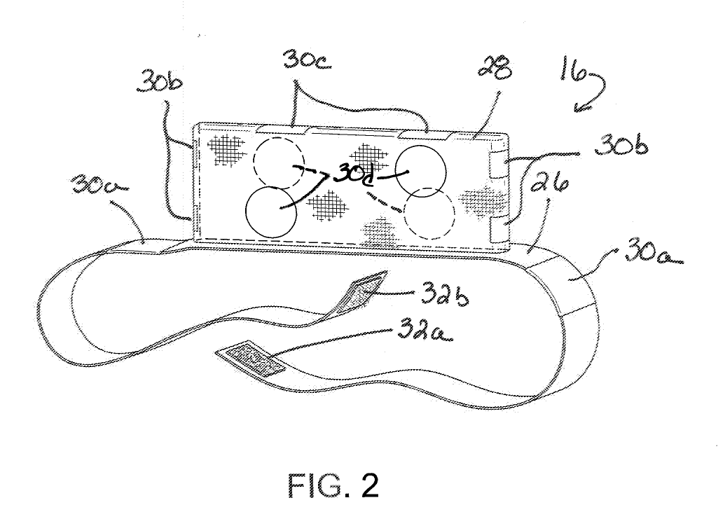

The garment 16 is generally shown in FIG. 1 in the form of a band having a strap portion 26, a projecting portion 28 and a series of reflectors 30. The band garment 16 is more particularly shown in FIG. 2. The band 16 is provided with strap 26 preferably made of an elastic web. The elasticity of the strap material is preferably chosen for comfort of the infant, while reasonably maintaining its place upon movement of the infant prior to and during sleeping, as well as after waking The strap 26 is provided with two loose ends that may be joined to create a loop. The two ends are shown as having an attachment structure 32 in the form of hook 32a and loop 32b fasteners. Other attachment means may be used. The position and/or length of the attachment structures may vary as desired, with adjustability of the strap 26 being preferred to accommodate different size infants.

There are a number of reflectors 30 provided on the garment 16. The strap 26 is shown to have reflectors 30a on opposite sides of the projection 28. The projection 28 is shown to include side reflectors 30b, top reflectors 30c, and front and back reflectors 30d. Any combination of the reflectors positions shown is possible and additional or other reflector positions may be added.

The reflectors 30 include a surface having a reflective property when subjected to a near infrared or infrared wavelength light source. The reflectors enable a relatively high visibility for the detector 12, which operates with a night vision or similar infrared capable mode. Additional markings may be added to the strap 26 and/or projection 28 for observation via the display 20 on the receiver 14.

The projecting portion 28 is contemplated to be a relatively soft and compliant material. A woven webbing material may be used. The projection 28 is attached to the strap 26 in any manner desired. A stiffening or filler material may be provided inside an outer cover portion to assist in maintaining the projected position on the strap. A base (not shown) may also be provided to attach the cover and/or filler to the strap 26, which may also stiffen the projection 28. The projection 28 may be removable from the strap 26 as desired. Hook and loop fasteners may be provided to secure the projection 28 at its base. All materials are contemplated to be washable and to conform to government or other standards for infant use.

The band 16 is adjustable and wraps around the circumference of the infant's abdomen and/or diaphragm. The strap 26 is positioned under the infant's arms, which will deter the band from moving up toward the head. The band 16 will maintain its position on the infant's body during sleeping. The projection 28 is provided to make the band 16 more visible to the emitter/receiver portion 18 of the detector 12. The reflectors 30 may be formed from non-toxic reflective tape and may be adhesively or otherwise secured to the strap 26 and projection 28.

The positioning of the reflectors 30 on the anterior, lateral and posterior aspects of the band 16 is contemplated to maximize the range of detectable positions and motion. Infants are abdominal breathers and the band 16 is so placed to provide motion to the reflectors. The band 16 may also be positioned upwardly from the abdomen to cross over the diaphragm region, if found appropriate for the individual infant.

The projection portion 28 of the garment 16 is contemplated to create a three dimensional aspect to the detection of infant movement. The strap component 26 is relatively two dimensional, moving up and down with each breath. The projection structure 28 stands erect and is preferably up to 3 inches in length and 2 inches in height, with a depth of up to ½ inch. The projection portion 28 is contemplated to effectively amplify visibility of the infant breathing pattern. Furthermore, the projection 28 will assist in detecting both voluntary and involuntary movement. The projection 28 is shown as being generally rectangular in shape, but may have other forms and contours.

The alarm lights 22 and speaker 24 may be programmed to activate under certain operational circumstances. Loss of signal, low battery and similar functional alarms are contemplated. In addition, the detector 12 may be provide with sufficient sensing capabilities to measure and analyze infant movement based on the position of the various reflectors 30. For example, the infant breathing pattern is relatively regular during sleep. Hence, movement of the reflectors 30 will be regular. A change in the regular pattern (which may be established over time) may result in an alarm signal being sent (wirelessly) from the detector 12 to the receiver 14. The alarm signal may activate a visual alarm by means of the lights 22 or by an announcement/sound generated from the speaker 24.

The change in breathing pattern may be evaluated and result in different levels of alarm signals. For example, a separate alarm signal may be defined for a random change in breathing pattern, whereas an elevated alarm signal is defined for a perceived discontinuation of breathing. Rotational movement of the infant, e.g., rolling over, will cause a different movement of the reflectors 30 and the detector 12 can be programmed to activate a different alarm signal. Movement consistent with the infant falling asleep or waking up from sleep may also be identified by set alarm signals. Other signal parameters may be defined or programmed into the operation of the system. Further, remote signals may be broadcast to a smart phone or like device. The alarms may be programmable as desired at the detector/receiver, through the receiving station, through a remote control (not shown), or through another device.

One potential advantage of the system is to alleviate stress for a care taker due to the lack of clarity within a standard baby monitor relative to the anatomical position of the infant. Another potential advantage of the contemplated system is to provide visual affirmation of the status of the infant by a highly visible identification system using the infrared emission and reflection. Further, movement of both the two-dimensional or three-dimensional positioning of the infant is possible, with an alarm system actively identifying the relative motion.

The present disclosure shows and describes an exemplary embodiment. It should be understood by those skilled in the art from the foregoing that various other changes, omissions and additions may be made therein, without departing from the spirit and scope of the contemplated invention, with the scope of the invention being defined by the foregoing claims. Further, the terms herein are used in a generic and descriptive sense and are not necessarily for purposes of limitation. The scope of the invention is set forth in the following claims.

What is claimed is:

1. A monitor system is provided for detection of the movement and position of a sleeping infant, the system comprising:
an infrared detector,
a remote receiving station, and
a garment to be worn by an infant, the garment provided with infrared reflectors that create positional markers for detection by the detector,
wherein the detector sends signals to the receiving station based on the position over time of the reflectors on the garment worn by the infant.

2. A monitor system as in claim 1, wherein the receiving station comprises alarms representative of the signals received from the detector.

3. A monitor system as in claim 1, wherein the detector further comprises a video camera.

4. A monitor system as in claim 3, wherein the receiving station comprises a visual display for displaying the signals from the detector and the camera.

5. A monitor system as in claim 4, wherein the receiving station comprises alarms responsive to signals received from the detector.

6. A monitor system as in claim 5, wherein the alarms are visual indicators of signals from the detector.

7. A monitor system as in claim 6, wherein the alarms provide an audible indication of signals from the detector.

8. A monitor system as in claim 1, wherein the garment comprises a band having infrared reflectors positioned thereon.

9. A monitor system as in claim 8, wherein the band comprises an elastic strap, and wherein an adjustable coupling is formed on the ends of the strap for securing the strap around the abdomen of an infant.

10. A monitor system as in claim 9, wherein the band further comprises a projecting structure attached to the strap, the projecting structure having reflectors provided thereon.

11. A monitor system as in claim 10, wherein the projecting structure is formed from a flexible, woven mesh material.

12. A monitor system is provided for detection of the movement and position of a sleeping infant, the system comprising:
a detector having a video camera and an infrared emitter and receiver, the detector including means for broadcasting video and other signals,
a receiving station having a video display and one or more indicators, the receiving station including means for receiving the broadcast video and other signals from the detector, and
a garment to be worn by an infant, the garment having an elastic strap, an adjustable coupling formed on the ends of the strap for securing the strap around the abdomen of an infant, and a flexible projecting structure attached to the strap, at least one of the strap and the projecting structure having infrared reflectors provided thereon that create positional markers for detection by the detector,
wherein the detector sends signals to the receiving station based on the position over time of the reflectors on the garment worn by the infant, and
wherein the receiving station indicators serve as alarms that are activated in response to signals positional received from the detector.

13. A monitor system as in claim 12, wherein the projecting structure is formed from a woven mesh material.

14. A monitor system as in claim 12, wherein the indicators provide a visual alarm based on the signals from the detector.

15. A monitor system as in claim 12, wherein the indicators provide an audible alarm based on the signals from the detector.

16. A method of monitoring movement and position of a sleeping infant, the method comprising the steps of:
providing an infrared detector,
providing a remote receiving station,
providing a garment having infrared reflectors thereon,
securing the garment on an infant prior to sleeping,
placing the infant wearing the garment within range of the infrared detector and activating the detector,
generating signals from the detector based on the positional markers created by the reflectors,
receiving detector signals at the receiving station, and
generating position identification information of the infant movement based on the detected position of the garment reflectors.

17. A method as in claim 16, wherein the detector further includes a video camera and the receiving station includes a visual display of camera signals from the detector.

18. A method as in claim 16, wherein the receiving station comprises alarms representative of the position identification signals received from the detector.

19. A method as in claim 16, wherein the alarms provide an audible alarm based on positional signals from the detector.

20. A method as in claim 16, wherein the garment includes an elastic strap having an adjustable coupling formed on the ends for securing the strap around the abdomen of an infant.

21. A method as in claim 16, wherein the garment further comprises a projecting structure attached to the strap, the projecting structure having reflectors provided thereon.
